(19) United States
(12) Patent Application Publication
(10) Pub. No.: US 2017/0213269 A1
(43) Pub. Date: Jul. 27, 2017

(54) CONSUMER-VENDOR INTERACTIONS IN A COMMERCE MESSAGING MEDIUM

(71) Applicants: NEIL BHARGAV SETLUR, CUPERTINO, CA (US); GOVINDARAJ NARAYANA SETLUR, CUPERTINO, CA (US)

(72) Inventors: NEIL BHARGAV SETLUR, CUPERTINO, CA (US); GOVINDARAJ NARAYANA SETLUR, CUPERTINO, CA (US)

(21) Appl. No.: 15/414,611

(22) Filed: Jan. 24, 2017

Related U.S. Application Data
(60) Provisional application No. 62/286,424, filed on Jan. 24, 2016.

(51) Int. Cl. G06Q 30/06; H04L 12/58

(52) U.S. Cl. CPC G06Q 30/0613; H04L 51/046

(57) ABSTRACT

A commerce-messaging medium over which consumers interact and transact with vendors is disclosed. The messaging medium is enabled by a platform that includes a back-end system, mobile applications, and browser-based or desktop applications. Consumers engage directly with vendor owners, employees, or representatives to communicate and conduct transactions. Consumers further engage with intermediary vendors who facilitate transactions with peer vendors or external vendors. The platform provides programmatic interfaces for vendors to integrate automated business operations, such as customer outreach, marketing, and sales operations, into the commerce-messaging medium. Messaging associated with automated business operations is transmitted over the medium to consumers.

### CROSS-REFERENCE TO RELATED APPLICATION

This application claims the benefit of U.S. Provisional Application No. 62/286,424, filed Jan. 24, 2016.

### FIELD OF THE INVENTION

The invention relates generally to communication systems, and specifically to messaging platforms for commerce.

### BACKGROUND

Consumer interest in interacting with commercial entities over non-traditional mediums has increased dramatically in recent years. Although telephone communication remains the primary method by which consumers interact with physical and non-physical (e.g. online) merchants, inherent limitations in the technology prevent novel, impactful functionality from being introduced over the same medium. Additionally, the rapid growth of smartphone usage means that many customers have access to internet-enabled smartphones and increasingly prefer to use these devices to interact not only with friends but also with merchant entities.

Text-based communication, otherwise known as messaging, has long been popular with smartphone users as a means of communicating with friends and relatives. Consumers now increasingly prefer to use this same medium to interact with merchant entities. Consumers further desire this messaging medium to incorporate multimedia such as images, video, audio, and maps, as well as button-based transactional capability, to augment and improve the user experience.

### SUMMARY

Consumers communicate with vendors and conduct transactions over a commerce-messaging medium. The messaging medium is enabled by a platform that includes a back-end system, mobile applications, and browser-based or desktop applications. Consumers can engage directly with vendor owners, employees, or representatives to conduct transactions. Consumers can engage with intermediary vendors who facilitate transactions with peer vendors or external vendors. The platform provides a programmatic interface for vendors to integrate automated business operations, such as customer outreach, marketing, and sales operations, into the commerce-messaging medium.

### DESCRIPTION OF DRAWINGS

FIG. 1 is a diagram of a commerce messaging platform, according to one embodiment.

FIG. 2 is a diagram of a vendor services API layer, according to one embodiment.

FIG. 3 is a diagram of a registered vendor, according to one embodiment.

FIG. 4 is a diagram of a transaction process involving a user and a registered vendor, according to one embodiment.

FIG. 5 is a diagram of a transaction process involving a user and a non-registered vendor, according to one embodiment.

### DETAILED DESCRIPTION

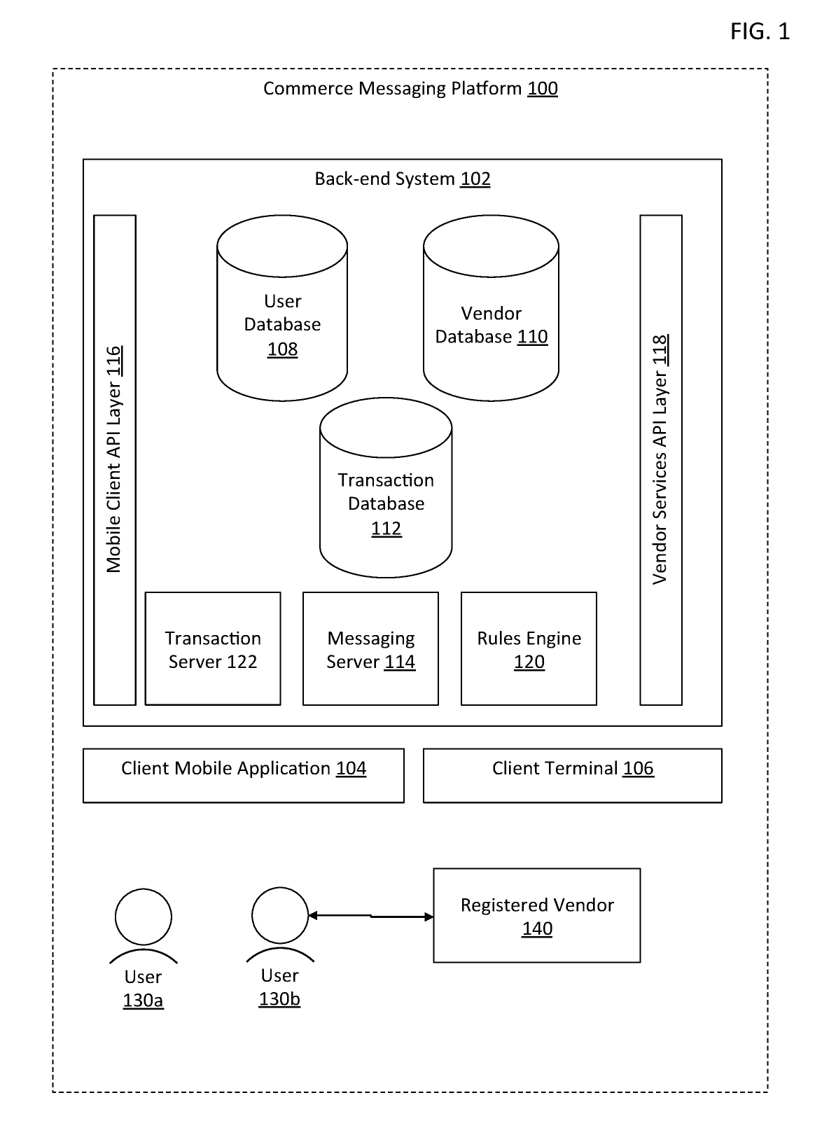

FIG. 1 depicts the environment of a commerce-messaging platform 100 (or “platform”). The platform 100 enables users 130 to interact with registered vendors 140 via a commerce-messaging medium (or “messaging medium” or simply “medium”). A registered vendor 140 represents a real business with a physical and/or online presence. For example, the registered vendor 140 could be (a) purely physical, like a neighborhood dry cleaner, (b) purely online, like a web hosting company, (c) or physical and online, such as a retailer with both a physical store location and a virtual online store. A user 130 creates a registered vendor 140, as will be described in detail later.

In order to enable communication between users 130 over the messaging medium as described previously, the platform 100 includes a back-end system 102, a client mobile application 104, and a client terminal 106. The back-end system 102, client mobile application 104, and client terminal 106 are developed, maintained, and/or administered by a single enterprise. The client mobile application 104 executes on a mobile device, smartphone, or other Internet-enabled device. Users 130 utilize the client mobile application 104 to enter and send messages, view received messages, and view previously sent messages. Users 130 also utilize the client mobile application 104 to search for and select registered vendors 140. In one embodiment, the client mobile application 104 allows the user 130 to send the same message to multiple registered vendors 140 at the same time. Users 130 can also create a new registered vendor 140 using the client mobile application 104. The client terminal 106 is a desktop, mobile, or browser-based application that is operated by a user 130 and executes on a computing device associated with a registered vendor 140. In one embodiment, a user 130 associated with a registered vendor 140 uses the client terminal 106 to view and respond to messages received by the registered vendor 140. In the example of FIG. 1, user 130b associated with registered vendor 140 uses the client terminal 106 to view and respond to messages sent to registered vendor 140 by user 130a. Additionally, multiple instances of the client terminal 106 may execute concurrently, allowing multiple users 130, each associated with the same registered vendor 140, to receive and respond to messages simultaneously.

In order to enable users 130 to interact with registered vendors 140 via the messaging medium of the platform 100, the back-end system 102 includes a user database 108, a vendor database 110, a transaction database 112, a messaging server 114, a mobile client API layer 116, a vendor services API layer 118, a rules engine 120, and a transaction server 122.

The user database 108 stores personal information and account information for each user 130, such as name, location, email, and so on. The vendor database 110 stores information describing each registered vendor 140 in the platform 100, including the vendor's name, category, location, hours, and associated users 130. The transaction database 112 stores information describing each transaction conducted between users 130 and registered vendors 140, including the amount of the transaction, the product or service which was purchased, the time and date of the transaction, and an identification of all of the users 130 involved in the transaction (including those associated with the registered vendor 140).

The messaging server 114 may be implemented according to one of a number of protocols. Some examples include but are not limited to XMPP and Web Sockets. The messaging server 114 is configured to organize, archive, and route messages sent between users 130 of the platform 100. The messaging server 114 may be configured to support multimedia messaging which includes text, images, video, and other forms of multimedia content such as emojis, GIFs, and so on.

The mobile client API layer 116 is configured to provide a standardized interface through which the client mobile application 104 and client terminal 106 can interact with the back-end system 102. The client mobile application 104 and client terminal 106 may be configured to use the mobile client API layer 116 to (among other functions) search for registered vendors 140, retrieve and edit user and vendor information, and initiate and process transactions.

The vendor services API layer 118 is configured to provide a standardized interface through which registered vendors 140 can consume additional services provided by the back-end system 102. These services, which will be described in detail later, may be used to augment, enhance, or complement the messaging functionality provided to registered vendors 140.

The rules engine 120 is configured to control the operations of and interactions between each of the components of the back-end system 102. In a typical embodiment, the rules engine 120 contains business logic that governs how users 130 and registered vendors 140 may interact with one another. The rules engine 120 also controls data transfer and organization within the user database 108, vendor database 110, and transaction database 112. The rules engine 120 additionally facilitates the execution of payment transactions involving the transaction server 122. Finally, the rules engine 120 manages requests for data or operations received from client applications (such as the client mobile application 104 and client terminal 106) via the mobile client API layer 116 and vendor services API layer 118.

The transaction server 122 is configured to control, monitor, and facilitate payment transactions between users 130 and registered vendors 140. The transaction server 122 is configured to interact with the transaction database 112, for purposes of carrying out transactions as well as storing and editing transaction records. The transaction server 122 is also configured to interact with external payment gateways or other payment processing services to facilitate payment transactions.

In a typical embodiment, a user 130 sends a request in the form of a message (or “query”) to one or more registered vendors 140. The message describes a request for a product or service (or information about the registered vendor 140). The message is received by the user(s) 130 who are associated with each recipient registered vendor 140. In the example depicted in FIG. 1, a message sent by user 130a to registered vendor 140 is received by user 130b. User 130b may be an owner or employee of the registered vendor 140. User 130a may be a customer inquiring about a product or service offered by the registered vendor 140. Users 130a and 130b may subsequently communicate via the messaging medium.

It should be noted that in the example embodiment of FIG. 1, User 130a may or may not be associated with another registered vendor 140. Additionally, multiple users 130 may be associated with registered vendor 140.

All entities and components described with reference to FIG. 1, including those contained within the back-end system 102, are configured to communicate and/or interact with one another. For the sake of simplicity, communication connections between each of these components are not depicted.

The vendor services API layer 118, described with reference to FIG. 1, is an interface through which registered vendors 140 can utilize the platform 100 (more specifically, the messaging medium that it enables) as a customer-engagement channel for a multitude of automated or system-driven processes. In a typical embodiment, a registered vendor's business activities include system-driven processes such as customer outreach and feedback, marketing efforts, sales operations, account management, and so on. Traditionally, these and other business activities are entirely automated, operating without direct human involvement, and rely on email as a medium for engaging users. The vendor services API layer 118 allows registered vendors 140 to use the messaging medium enabled by the platform 100 as a primary means for engaging users 130.

In one embodiment, the vendor services API layer 118 includes a message automation portal 202, a transaction portal 204, and an input request portal 206. Each portal serves as an interface for a class or category of system-driven processes belonging to a registered vendor 140. In a typical embodiment, the registered vendor 140 submits content, such as an account management message or promotional advertisement, to the portal. It is then received and processed by the rules engine 120. The rules engine 120 may interact with the messaging server 114, transaction server 122, and databases (108, 110, 112) to relay the content to one or more users 130. Specifically, the content is transmitted to and displayed within the client mobile application 104. The content may be displayed as part of a persisted “conversation”. The conversation includes a user 130 and the registered vendor 140 which originated the content, and displays all communication between the two parties from some time in the past to the current time. Some of this communication may include text-based “human-to-human” communication between the user 130 and an owner, employee, or representative of the registered vendor 140.

The message automation portal 202 allows a registered vendor 140 to transmit automated messages to a user 130 over the messaging medium. These messages can be periodic or repetitive. Some examples of automated messages that could be transmitted through the message automation portal 202 include monthly statements, order confirmations, tickets and boarding passes, and general marketing/outreach content.

The transaction portal 204 allows a registered vendor 140 to initiate and execute a transaction involving a user 130 via the messaging medium. In one embodiment, if a user 130 wishes to purchase a product or service from a registered vendor 140, the registered vendor 140 may initiate a transaction via the transaction portal 204. The user 130 receives, on his/her client mobile application 104, details describing the intended transaction as well as a request to approve the transaction.

The input request portal 206 allows a registered vendor 140 to transmit requests for user input via the messaging medium. Requests for user input may include requests for account verification, other account management requests, and requests for customer feedback (e.g., surveys and questionnaires).

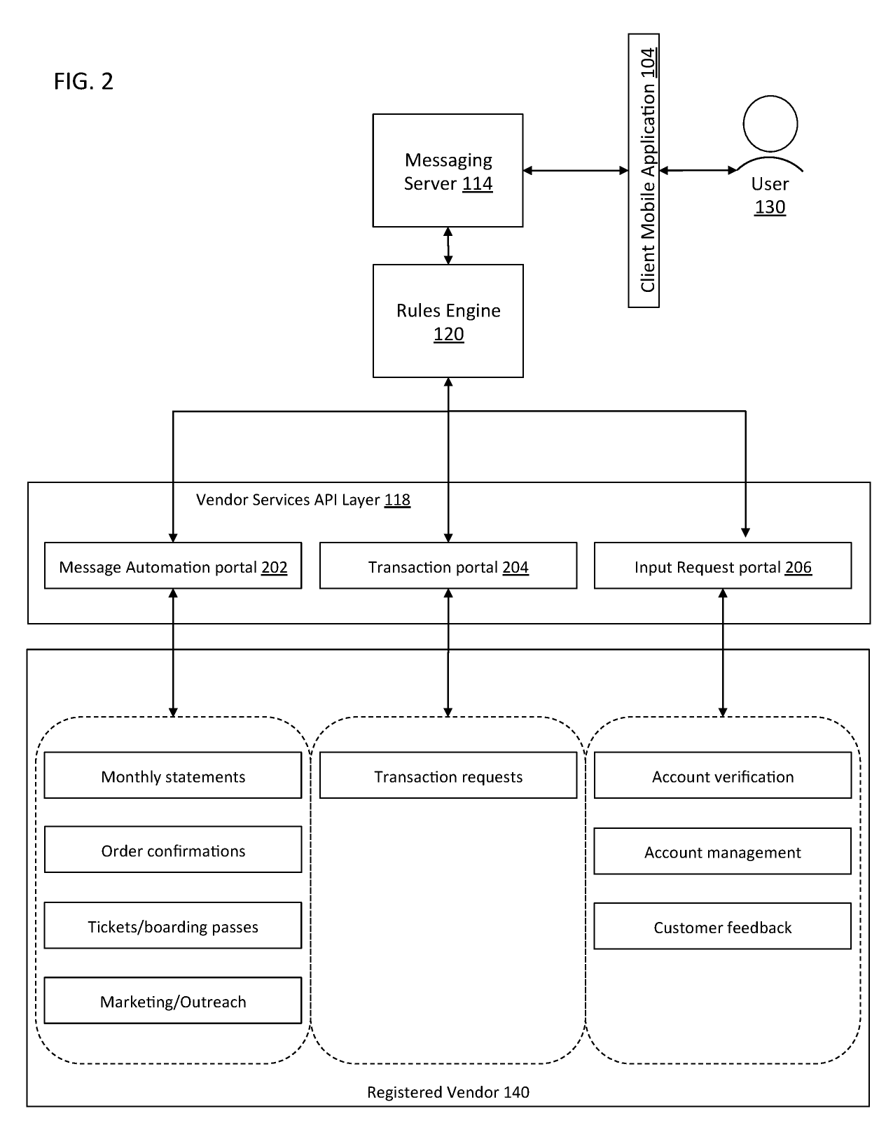

Registered vendors 140, as described previously with reference to FIGS. 1 and 2, receive messages sent by users 130 of the platform 100. In a typical embodiment, other users 130 associated with a registered vendor 140 receive and respond to these messages.

In one embodiment, a registered vendor 140 receives a high volume of messages from users 130 and must service them at an elevated rate (known as a “high throughput” situation). In this instance, a registered vendor 140 may maintain a customer service organization consisting of one or more representatives. These representatives collaborate to service each request received by the registered vendor 140.

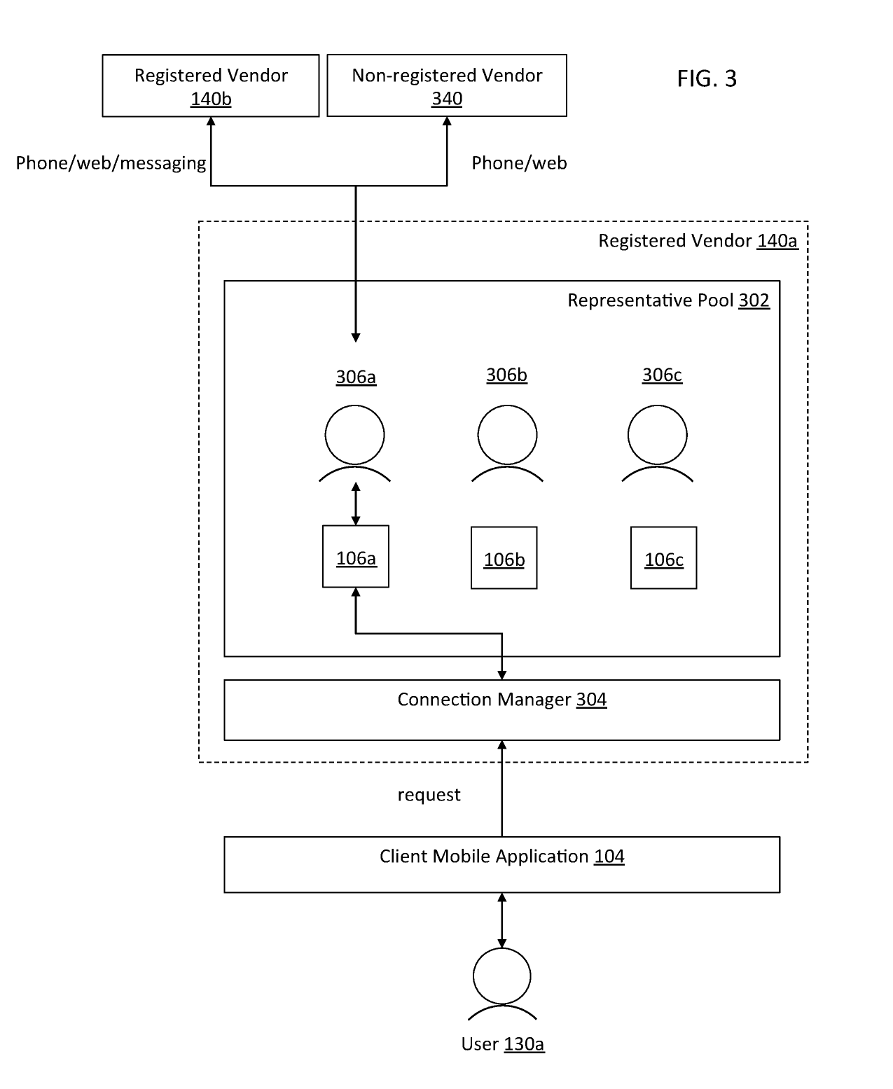

FIG. 3. includes a user 130a engaged in communication with a registered vendor 140a. The user 130a, via the client mobile application 104 executing on his/her smartphone or mobile device, sends a request to the registered vendor 140a. As described previously, the registered vendor 140a is configured to service a high volume of requests from other users 130. The request sent by user 130a is first received by a connection manager 304.

The connection manager 304 may be implemented by a combination of software and/or hardware, and is configured to route the request to one of multiple representatives associated with the registered vendor 140a. In the example of FIG. 3, registered vendor 140a includes a representative pool 302. The representative pool 302 further includes three representatives 306a, 306b, and 306c, each operating an instance of the client terminal 106 (a registered vendor 140 can contain hundreds or even thousands of representatives). In the example of FIG. 3, representative 306a uses client terminal 106a, representative 306b uses client terminal 106b, and representative 306c uses client terminal 106c. It should be noted that representative pool 302 can be a virtual or physical entity. In one embodiment, representative pool 302 is simply a physical space shared by the representatives 306. In another embodiment, representative pool 302 is a virtual space that each representative 306 accesses remotely.

The request sent by user 130a is routed by the connection manager 304 to one of the available representatives 306. In the example of FIG. 3, the request is routed to representative 306a. Representative 306a can service the request in multiple ways. In one embodiment, representative 306a services the request by referencing an internal information source specific to the registered vendor 140a. For example, if the user 130a is inquiring about the delivery status of a recent order, the representative 306a may consult an internal order tracking system. Or, if the user 130a requests specific information regarding customization options for one of the products offered by the registered vendor 140a, the representative 306a may consult another employee who is knowledgeable on the subject.

Representatives 306 may also contact other registered vendors 140 in order to service a request. As shown in FIG. 3, representative 306a contacts registered vendor 140b. This contact may occur in multiple channels, including over the phone, via a website published by registered vendor 140b, or by sending a message within the platform 100 to the registered vendor 140b. If representative 306a sends a request via messaging, then a user 130 or representative 306a associated with vendor 140b can receive and respond to the request.

Representatives 306 may also contact non-registered vendors 140 in order to service a request. Non-registered vendors 340 are considered “external” or “unaffiliated”, and as such, cannot be contacted via the platform 100. As shown in FIG. 3, representative 306a contacts a non-registered vendor 340. This contact occurs according to traditional channels, including over the phone or via a website published by non-registered vendor 340.

In some embodiments, a registered vendor 140 is staffed, maintained, and operated by the same enterprise that develops and maintains the back-end system 102, client mobile application 104, and client terminal 106. This registered vendor 140 is identified as a “concierge” service or “concierge vendor”. The concierge vendor may field general or non-specific requests from users 130 and representatives of the concierge vendor may fulfill these requests by contacting other registered vendors 140 or non-registered vendors 340. The concierge vendor facilitates transactions between users 130 and non-registered vendors 340 (as will be described in detail later).

As described previously, users 130 can purchase products or services from registered vendors 140 over the messaging medium enabled by the platform 100.

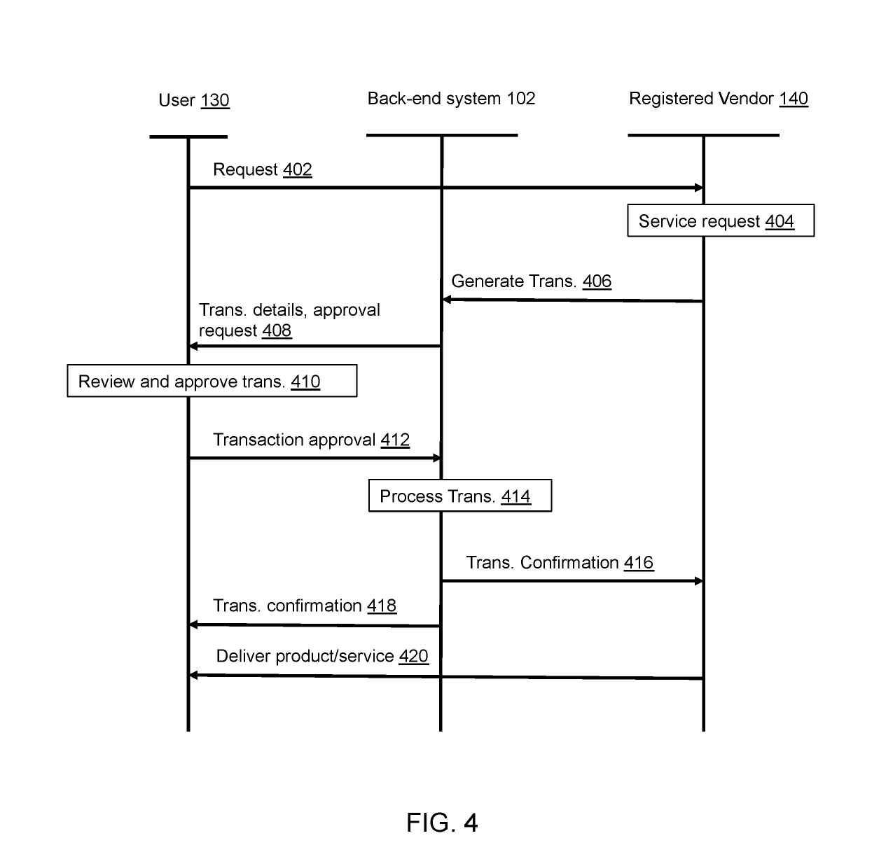

FIG. 4 depicts an example embodiment of a transaction conducted between a user 130 and a registered vendor 140 via the back-end system 102 of the platform 100. Using the client mobile application 104 on his/her smartphone device, a user 130 sends 402 a request for a product or service to a registered vendor 140. The registered vendor 140 services 404 the request. As described previously, the actual servicing may be carried out by a user 130 or representative 306 associated with the registered vendor 140. If the request concerns a product or service that is available from the registered vendor 140, the registered vendor 140 then generates 406 a transaction.

Generation of a transaction may be accomplished in one of multiple ways. In one embodiment, a representative 306 directs a computer server of the registered vendor 140 to generate a transaction via the transaction portal 204 within the vendor services API layer 118 of the back-end system 102 (first described with reference to FIG. 2). Or, in another embodiment, the representative 306 utilizes his/her client terminal 106 to generate the transaction via the transaction portal 204. As part of generating a transaction, the representative 306 enters specific details describing the transaction, such as the product or service being purchased, the amount and currency of the transaction, and an identification of the buyer and the representative 306.

The back-end system 102 receives the transaction via the transaction portal 204 of the vendor services API layer 118. The transaction server 122 of the back-end system 102 may perform verification, risk analysis, or other pre-processing steps to determine the legitimacy of the intended transaction. The back-end system 102 subsequently transmits 408 the transaction details as well as an approval request to the user 130. As described with reference to previous figures, the transaction details and approval request are displayed within a messaging interface in the client mobile application 104 of the user 130. In one embodiment, the transaction details and approval request are displayed in the same messaging interface containing the current conversation between the user 130 and the representative 306. The user 130 reviews and approves 410 the transaction by tapping a button or typing a message. The approval is transmitted 412 from the user 130 to the back-end system 102.

The transaction server 122 of the back-end system 102 processes 414 the transaction. In one embodiment, the transaction server 122 charges a payment instrument belonging to the user 130 for the amount of the product or service being purchased and credits an account of the registered vendor 140 with an equal amount. The transaction server 122 may retrieve and edit payment instrument information stored in the transaction database 112 in order to process the transaction. The transaction server 122 also stores a record of the transaction in the transaction database 112.

Subsequent to successful completion of the transaction, the back-end system 102 transmits 416 a confirmation message to the registered vendor 140. The confirmation message may be displayed to the representative 306 in his/her client terminal 106; it may also be stored in a computer server of the registered vendor 140 as part of regular transactional recordkeeping. The back-end system 102 then transmits 418 a confirmation message to the user 130. The confirmation message is displayed in the client mobile application 104 of the user 130. The confirmation message may be displayed in the same messaging interface containing the conversation between the user 130 and the representative 306.

Asynchronously, the registered vendor 140 delivers 420 the product or service to the user 130. Delivery of the product or service can be carried out according to existing order fulfillment processes.

As described previously, registered vendors 140 can facilitate transactions involving users 130 and non-registered vendors 340.

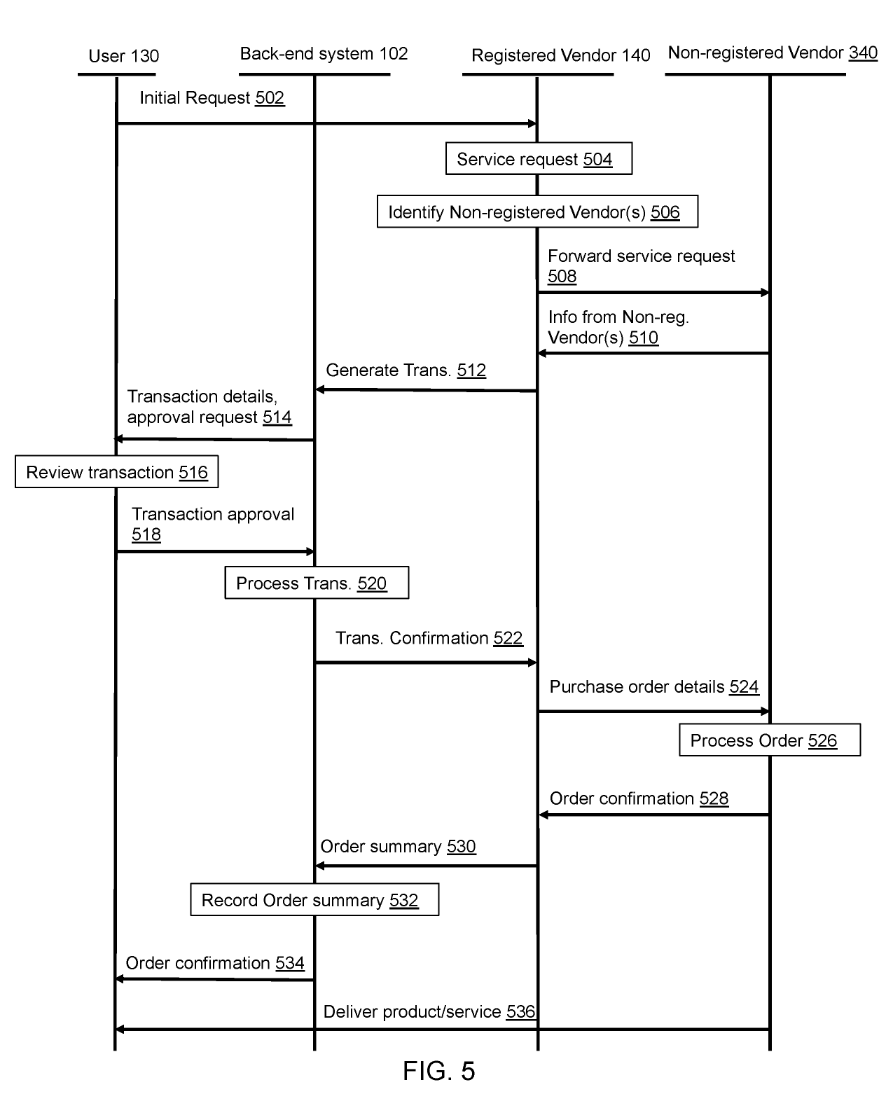

FIG. 5 depicts an example embodiment of a transaction involving a user 130 and a non-registered vendor 340, and facilitated by a registered vendor 140 via the back-end system 102. Using the client mobile application 104 on his/her smartphone device, a user 130 sends 502 a request for a product or service to a registered vendor 140. The registered vendor 140 services 504 the request. As described previously, the actual servicing may be carried out by another user 130 or representative 306 associated with the registered vendor 140. The nature of the request may require it to be fulfilled by a non-registered vendor 340.

Accordingly, the registered vendor 140 identifies 506 one or more non-registered vendors 340 to which to forward the request. The registered vendor 140 forwards 508 the service request to these non-registered vendors 340 via existing channels (phone and/or web). Forwarding of the request can be accomplished in one of multiple ways. In one embodiment, a representative 306 contacts each non-registered vendor 340 by telephone and negotiates directly with a representative of the non-registered vendor 340. In another embodiment, the representative 306 accesses a website of the non-registered vendor 340 and determines if the non-registered vendor 340 is capable of fulfilling the request. If one of the non-registered vendors 340 indicates that it is able to fulfill the request, or if the representative 306 of the registered vendor 140 determines that a non-registered vendor 340 is able to fulfill the request, then the registered vendor 140 proceeds to generate 512 a transaction.

As described with reference to FIG. 4, generation of a transaction may be accomplished in one of multiple ways. In one embodiment, a representative 306 directs a computer server of the registered vendor 140 to generate a transaction via the transaction portal 204 within the vendor services API layer 118 of the back-end system 102 (first described with reference to FIG. 2). In another embodiment, the representative 306 generates the transaction via his/her client terminal 106, which transmits the transaction to the back-end system 102 via the transaction portal 204 of the vendor service API layer 118. The generated transaction indicates that the service request is being fulfilled by a non-registered vendor 340 and facilitated by the registered vendor 140. The generated transaction also includes details describing the transaction, such as the product or service being purchased, the amount and currency of the transaction, an identification of the buyer, an identification of the non-registered vendor 340, and if applicable, an identification of the representative 306 responsible for facilitating the transaction.

The back-end system 102 receives the generated transaction via the transaction portal 204 of the vendor services API layer 118. The transaction server 122 of the back-end system 102 may perform verification, risk-based analysis, or other pre-processing steps to determine the legitimacy of the intended transaction. The back-end system 102 subsequently transmits 514 the transaction details as well as an approval request to the user 130. As described with reference to previous figures, the transaction details and approval request are displayed within a messaging interface in the client mobile application 104 of the user 130. In one embodiment (as described with reference to FIG. 4), the transaction details and approval request are displayed in the same messaging interface containing the current conversation between the user 130 and the representative 306. The user 130 reviews and approves 516 the transaction by tapping a button or typing a message. The approval is transmitted 518 from the user 130 to the back-end system 102.

The transaction server 122 of the back-end system 102 processes 520 the transaction. In one embodiment, the transaction server 122 charges a payment instrument belonging to the user 130 in the amount of the product or service being purchased and credits an account of the registered vendor 140 with an equal amount. The transaction server 122 may retrieve and edit payment instrument information stored in the transaction database 112 in order to process the transaction. The transaction server 122 also stores a record of the transaction in the transaction database 112.

Subsequent to successful completion of the transaction, the back-end system 102 transmits 522 a confirmation message to the registered vendor 140. The confirmation message may be displayed to the representative 306 in his/her client terminal 106; it may also be stored in a computer server of the registered vendor 140 as part of regular transactional recordkeeping. Subsequently, the registered vendor 140 transmits 524 a purchase order to the non-registered vendor 340 indicating the product or service to be purchased. Transmission of the purchase order can be accomplished in multiple ways: for example, by describing a purchase order to the non-registered vendor 340 over the phone, or by placing a purchase order via an online checkout page of the non-registered vendor 340.

Subsequently, the non-registered vendor 340 processes 526 the order. At this time, the non-registered vendor 340 may also collect payment from the registered vendor 140. In one embodiment, the registered vendor 140 acts as a proxy agent for the purchase; in other words, the non-registered vendor 340 treats the registered vendor 140 as the purchaser of the product or service. Accordingly, the non-registered vendor 340 charges a payment instrument associated with the registered vendor 140. This payment instrument may be stored in perpetuity by the non-registered vendor 340 or it may be provided to the non-registered vendor 340 at the time of purchase. The non-registered vendor 340 returns 528 an order confirmation to the registered vendor 140.

The registered vendor 140 transmits 530 an order summary to the back-end system 102. The order summary includes information such as a description of the product or service, the amount and currency, and the time and date of the purchase. The transaction server 122 of the back-end system 102 records 532 the order summary by creating a new record in the transaction database 112. The transaction server 122 also verifies that the amount, product description, and other details of the order summary match the transaction conducted previously between the user 130 and the registered vendor 140

Subsequently, the back-end system 102 transmits 534 an order confirmation message to the user 130. The order confirmation is displayed in the client mobile application 104 of the user 130, and indicates what product or service was purchased by the registered vendor 140 on behalf of the user 130 as well as other relevant order details. As described earlier, the order confirmation may be displayed in the same messaging interface containing the conversation between the user 130 and the representative 306 of the registered vendor 140.

Asynchronously, the non-registered vendor 340 delivers 536 the product or service to the user 130. Delivery of the product or service can be carried out according to existing order fulfillment processes.

What is claimed is:

1. A method for transmitting data between users associated with a virtual entity in a digital messaging system, comprising:
Recording a virtual entity created by a first user of the digital messaging system, the virtual entity associated with the first user;
Receiving, from a second user of the digital messaging system, a selection identifying the virtual business;
Receiving a message transmitted by the second user of the digital messaging system;
Based on the selection identifying the virtual business, retrieving a record of the virtual business;
Responsive to the association between the virtual business and the first user, identifying the first user as a recipient of the message; and
Relaying the message to the first user.

2. A system comprising:
A client mobile application;
A client terminal; and
A back-end system comprising:
A mobile client API layer, configured to provide a standardized interface through which the client mobile application and client terminal can interact with the back-end system,
A vendor services API layer, configured to provide a standardized interface through which a vendor can consume a service provided by the back-end system;
A user database, configured to store information associated with one or more users,
A vendor database, configured to store information associated with one or more vendors,
A transaction database, configured to store information associated with one or more transactions,
A transaction server, configured to facilitate and process one or more transactions,
A messaging server, configured to transmit one or more messages, and
A rules engine, configured to control one or more entities comprising the back-end system.
